(19) United States
(12) Patent Application Publication
(10) Pub. No.: US 2023/0141937 A1
(43) Pub. Date: May 11, 2023

(54) COIL FORMING APPARATUS AND COIL FORMING METHOD

(71) Applicant: HONDA MOTOR CO., LTD., Tokyo (JP)

(72) Inventors: Junya OCHIAI, Tokyo (JP); Eishi YOSHIDA, Tokyo (JP); Yutaka MATSUMOTO, Tokyo (JP); Shuhei OKUDA, Tokyo (JP)

(21) Appl. No.: 18/048,042

(22) Filed: Oct. 20, 2022

(30) Foreign Application Priority Data
Nov. 11, 2021 (JP) 2021-184408

(51) Int. Cl. H02K 15/04; B21F 45/00

(52) U.S. Cl. CPC H02K 15/0478; B21F 45/00

(57) ABSTRACT

A coil forming apparatus for precisely reforming a band-shaped coil having straight portions and side ends, in an arc shape includes: a coil winding jig for inserting the straight portions into comb-shaped grooves thereof and winds; a coil conveying mechanism for pivotally conveying the band-shaped coil; and guide members for guiding the side ends, and inserts each of the straight portions into a respective one of the plurality of comb-shaped grooves, in which the coil conveying mechanism unit has a conveying rail and a conveyor, the conveyor has a plurality of gripping grooves for gripping a respective one of the plurality of straight portions, the plurality of gripping grooves having a coil abutting bottom surface of a depth according to an overlapping number of the plurality of straight portions which differs according to position in the conveying direction of the band-shaped coil.

This application is based on and claims the benefit of priority from Japanese Patent Application No. 2021-184408, filed on 11 Nov. 2021, the content of which is incorporated herein by reference.

### BACKGROUND OF THE INVENTION

### Field of the Invention

The present invention relates to a coil forming apparatus and a coil forming method.

### Related Art

The stator of a rotary electric machine has a band-shaped coil in a wound state. The band-shaped coil is formed in advance in a substantially cylindrical wound state having a smaller diameter than the inside diameter of the stator core, and is inserted inside of the stator core. The band-shaped coil in the wound state is expanded in diameter inside of the stator coil, and is mounted by inserting the straight portion of the band-shaped coil into a slot of the stator core.

Conventionally, it has been known to mold the band-shaped coil into a wound state of substantially cylindrical shape by winding on a coil winding jig, while feeding by one pitch at a time on the columnar coil winding jig (for example, refer to Patent Document 1).
Patent Document 1: Japanese Patent No. 4953032

### SUMMARY OF THE INVENTION

When forming the coil into the wound state by winding the coil, it is important that a plurality of straight portions are wound accurately without displacing. In the above prior art, by inserting a preliminary alignment member between adjacent straight portions in a position immediately preceding the coil winding jig on the conveying path of the band-shaped coil, the superposition of the immediately preceding straight portion to be wound in the coil winding jig is aligned.

However, in the above prior art, there is no specific disclosure about how the band-shape coil is made and conveyed and wound to the coil winding jig, and in particular, upon winding in the coil winding jig, no special viewpoint is shown for the way of reforming the band-shaped coil into an arc shape so as to follow the outer circumference of the coil winding jig. If this reforming is not favorably carried out, the band-shaped coil will not reach the wound state in accordance with the specification, and there is concern over producing poor quality. The occurrence of poor quality leads to an increase in material consumption, leading to wasteful consumption of resources. In addition, the operating time of manufacturing equipment required to achieve the scheduled production volume is extended, and the electrical consumption increases. For this reason, it consequently has an adverse impact on the global environment.

The present invention has been made taking account of the above-mentioned situation, and has an object of providing a coil forming apparatus and coil forming method which can easily form a band-shaped coil into a predetermined wound state, by precisely reforming into an arc shape so as to follow the outer circumference of a coil winding jig. So long as it is possible to process the band-shaped coil into a predetermined wound state with high yield without introducing a defective product, since it is possible to suppress wasteful consumption of resources, curb the operating time of manufacturing equipment, and save on electrical energy, it will contribute to preservation of the global environment.

A coil forming apparatus (for example, the coil forming apparatus 1 described later) according to a first aspect of the present invention forms a band-shaped coil (for example, the band-shaped coil 100 described later) in a wound state, the band-shaped coil including a plurality of straight portions (for example, the straight portion 102 described later) and side ends (for example, the side end 103 described later) provided on both ends of the plurality of straight portions, the coil forming apparatus including: a coil winding jig (for example, the coil winding jig 2 described later) having a plurality of comb-shaped grooves (for example, the comb-shaped groove 23 described later), and configured to be capable of winding the band-shaped coil by inserting the plurality of straight portions of the band-shaped coil into a respective on the plurality of comb-shaped grooves; a coiling conveying mechanism unit (for example, the coil conveying mechanism unit 3 described later) configured to be capable of pivotal conveying the band-shaped coil; and guide members (for example, the guide member 4 described later) that are provided in a vicinity of both ends of the coil winding jig in an axial direction, and guide the band-shaped coil in an arc shape while being in contact with the side end of the band-shaped coil, and insert the plurality of straight portions in a respective one of the plurality of comb-shaped grooves in a second half portion of pivotal conveying of the band-shaped coil, in which the coil conveying mechanism unit includes a conveying rail (for example, the conveying rail 31 described later) that provides a conveying path pivotally conveying the band-shaped coil along the coil winding jig, and a conveyor (for example, the conveyor 32 described later) that moves along the conveying rail in a state gripping each of the plurality of straight portions of the band-shaped coil, the conveyor has a plurality of gripping grooves (for example, the gripping groove 321 described later) which grip a respective one of the plurality of straight portions of the band-shaped coil, and the plurality of gripping grooves have a coil abutting bottom surface (for example, the coil abutting bottom surface CCB described later) of a depth according to an overlapping number of the plurality of straight portions which differ according to position in a conveying direction of the band-shaped coil.

According to a second aspect of the present invention, in the coil forming apparatus as described in the first aspect, the coil abutting bottom surface may be a bottom part (for example, the upper end surface 331a of the piece member main body 331 which is the bottom part described later) of each of the plurality of gripping grooves provided at a site at which the plurality of piece members (for example, the piece member 33 described later) adjoin of the conveyor configured by a plurality of the piece members which are rotatable accompanying pivotal conveying of the band-shaped coil while gripping the plurality of straight portions being coupled to overlap along the conveying direction of the band-shaped coil.

According to a third aspect of the present invention, in the coil forming apparatus as described in the first or second aspect, the guide members may include a reforming portion (for example, the reforming portion 42 described later) in a first half portion of the band-shaped coil upon pivotal conveying, and the reforming portion deforms and reforms the band-shaped coil in an arc shape in a state sandwiching the side ends of the band-shaped coil in a state gripping the plurality of straight portions in the plurality of gripping grooves.

A coil forming method according to a fourth aspect of the present invention forms a band-shaped coil (for example, the band-shaped coil 100 described later) in a wound state, the band-shaped coil including a plurality of straight portions (for example, the straight portion 102 described later) and side ends (for example, the side end 103 described later) provided on both ends of the plurality of straight portions, the method including: a coil conveying step of pivotally conveying the band-shaped coil in a state gripping each of the plurality of straight portions, along a coil winding jig (for example, the coil winding jig 2 described later), the coil winding jig including a plurality of comb-shaped grooves (for example, the comb-shaped groove 23 described later) on an outer periphery thereof, each of which can hold a respective one of the plurality of straight portions therein, and being configured to wind the band-shaped coil, and a guiding step of providing guide members (for example, the guide member 4 described later) in a vicinity of both ends of the coil winding jig in an axial direction, guiding the band-shaped coil so as to be in an arc shape while the side ends of the band-shaped coil being pivotally conveyed are in contact with the guide members, and inserting the plurality of straight portions into a respective one of the plurality of comb-shaped grooves of the coil winding jig, in which the coil conveying step uses a conveyor (for example, the conveyor 32 described later) having gripping grooves (for example, the gripping groove 321 described later) having a coil abutting bottom surface (for example, the coil abutting bottom surface CCB described later) of a depth according to an overlapping number of the plurality of straight portions which differs according to position in a conveying direction of the band-shaped coil to grip the plurality of straight portions by the gripping grooves.

According to a fifth aspect of the present invention, in the coil forming method as described in the fourth aspect, the coil conveying step may be configured to use the conveyor in which a plurality of piece members (for example, the piece member 33 described later) which are rotatable accompanying pivotal conveying of the band-shaped coil while gripping the plurality of straight portions are coupled to overlap along the conveying direction of the band-shaped coil, and grip the plurality of straight portions by the gripping groove in which the coil abutting bottom surface is provided as a bottom of each of the plurality of gripping grooves provided at a site where the plurality of piece members adjoin.

According to a sixth aspect of the present invention, in the coil forming method as described in the fourth or fifth aspect, the coil conveying step may further include a reforming step (for example, step performing reforming by the reforming portion 42 described later) of deforming and reforming the band-shaped coil in an arc shape, by sandwiching the side ends of the band-shaped coil in a state gripping the plurality of straight portions in the plurality of gripping grooves, in a first half portion of the band-shaped coil upon pivotal conveying.

In the coil forming apparatus according to the first aspect of the present invention, the plurality of gripping grooves gripping a respective one of the straight portions includes the coil abutting bottom surface of a depth according to an overlapping number of the plurality of straight portions which differs according to the position in the conveying direction of the band-shaped coil. For this reason, upon deforming and reforming on the band-shaped coil into an arc shape, force acts appropriately on the coil abutting bottom surface functioning as the force point and working point giving force for this reforming, and from the corresponding site of the guide member as the fulcrum relative to this. Therefore, it is possible to perform predetermined reforming on the band-shaped coil.

According to the coil forming apparatus as described in the second aspect, the conveyor is configured by the plurality of piece members which are rotatable accompanying pivotal conveying of the band-shaped coil being coupled to overlap along the conveying direction of the band-shaped coil, the gripping grooves are formed at every site at which the plurality of piece members adjoin, and the bottom part of this gripping groove makes the coil abutting bottom surface. For this reason, the convey can pivotally convey the coil conductors of the band-shape coil smoothly in an arc shape while gripping by the gripping grooves.

According to the coil forming apparatus as described in the third aspect, in the reforming portion, the band-shaped coil is deformed and reformed in an arc shape in a state sandwiching the side ends of the band-shaped coil in a state in which the coil conductors of the straight portions are gripped in the plurality of gripping grooves. For this reason, the force for making the bending habit in the band-shaped coil acts appropriately, and thus it is possible to make a predetermined bending habit in the band-shaped coil.

According to the coil forming method as described in the fourth aspect, the plurality of gripping grooves gripping a respective one of the coil conductors of the straight portions exactly support the coil conductors at the deepest part of the gripping groove by the coil abutting bottom surface of a depth according to the overlapping number of the plurality of straight portions which differs according to the position in the conveying direction of the band-shaped coil. For this reason, upon deforming and reforming on the band-shaped coil into an arc shape, force acts appropriately on the coil abutting bottom surface functioning as the force point and working point giving force for this reforming, and from the corresponding site of the guide member as the fulcrum relative to this. Therefore, it is possible to perform predetermined reforming on the band-shaped coil.

According to the coil forming method as described in the fifth aspect, the conveyor is configured by the plurality of piece members which are rotatable accompanying pivotal conveying of the band-shaped coil being coupled to overlap along the conveying direction of the band-shaped coil, the gripping grooves are formed at every site at which the plurality of piece members adjoin, and the bottom part of this gripping groove makes the coil abutting bottom surface. For this reason, the band-shaped coil can be pivotally conveyed by the conveyor smoothly in an arc shape by gripping the coil conductors by the gripping grooves.

According to the coil forming method as described in the sixth aspect, in the reforming portion, the band-shaped coil is deformed and reformed in an arc shape in a state sandwiching the side ends of the band-shaped coil in a state in which the coil conductors of the straight portions are gripped in the plurality of gripping grooves. For this reason, the force for making the bending habit in the band-shaped coil acts appropriately, and thus it is possible to make a predetermined bending habit in the band-shaped coil.

In addition, the coil forming apparatus as described in the first to third aspects, and the coil forming method as described in the fourth to sixth aspects are collectively premised on using material made into a series of band-shaped coils in advance, as the coils set in the stator. Upon setting the coil into the slot of the stator, the current mainstream technique is a technique which divides and forms the coil into a plurality of segments, and after inserting into the slots, welds the coil ends. In this general technique, it is necessary to use high purity copper in the coil so as to be able to withstand the thermal processing at the weld location. In contrast, since coping with the thermal processing is unnecessary with the present invention, it is possible to use recycled copper wire containing impurities, which can contribute to the realization of the recycling of resources.

### BRIEF DESCRIPTION OF THE DRAWINGS

FIG. 1 is a side view showing an embodiment of a coil forming apparatus of the present invention;

FIG. 2 is a drawing viewing the coil forming apparatus shown in FIG. 1 from the A direction in FIG. 1;

FIG. 3 is a drawing viewing the coil forming apparatus shown in FIG. 1 from the B direction in FIG. 1;

FIG. 4 is a perspective view showing an embodiment of a coil winding jig;

FIG. 5 is a perspective view showing a piece member of a grip portion of a coil conveying mechanism unit;

FIG. 6 is a perspective view showing an aspect viewing the piece member of the grip portion of the coil conveying mechanism unit from the opposite side of FIG. 5;

FIG. 7 is a perspective view showing a state connecting two piece members;

FIG. 8 is an enlarged view of a portion E in FIG. 1;

FIG. 9 is an enlarged view of a portion C in FIG. 1;

FIG. 10 is a cross-sectional view showing an aspect of the band-shaped coil being guided into an arc shape in the coil winding jig by a guide member;

FIG. 11 is an enlarged cross-sectional view of a portion D in FIG. 1;

FIG. 12 is a partial enlarged view showing an aspect of the band-shaped coil being wound multiply on the coil winding jig;

FIG. 13 is a perspective view showing a state in which the band-shaped coil is molded in a wound state on the coil winding jig;

FIG. 14A is a conceptual diagram showing the band-shaped coil in a side view by expanding in the direction of the conveying path of linear shape of the coil forming apparatus shown in FIG. 1.

FIG. 14B is a conceptual diagram showing the coil conveying mechanism unit in a side view by expanding in the direction of conveying path of linear shape of the coil forming apparatus shown in FIG. 1.

FIG. 14C is a conceptual diagram showing in a side view the shape in a case of gripping the band-shaped coil of FIG. 14A by the coil conveying mechanism unit of FIG. 14B.

FIG. 15A is a view for explaining an aspect of deforming and reforming the band-shaped coil gripped in the coil conveying mechanism unit into an arc shape by a reforming portion of a guide member.

FIG. 15B is a view for explaining the operation of reforming in FIG. 15A.

### DETAILED DESCRIPTION OF THE INVENTION

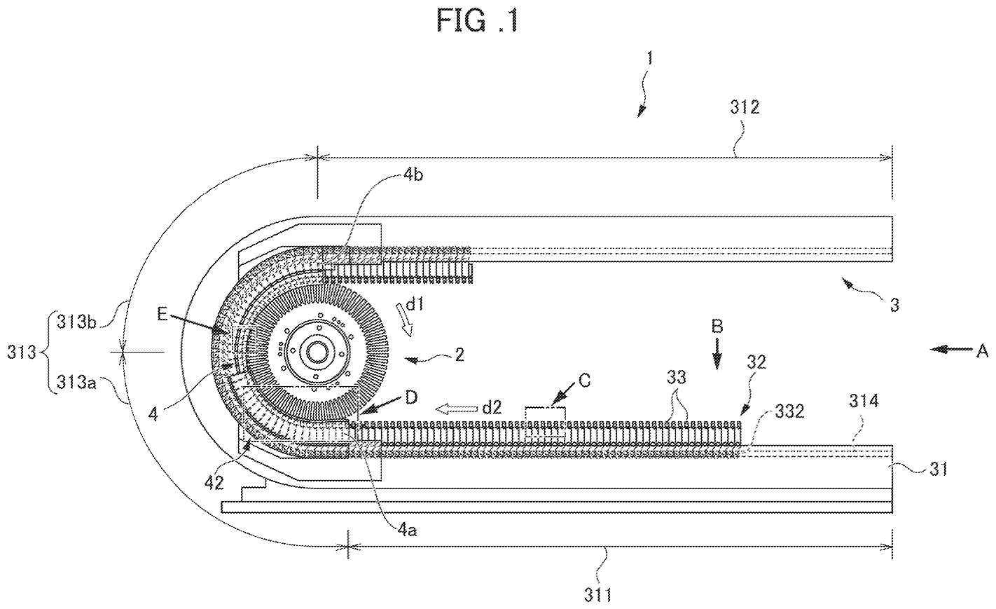

Hereinafter, an embodiment of the present invention will be explained. As shown in FIG. 1, a coil forming apparatus 1 of the present embodiment includes: a coil winding jig 2; a coil conveying mechanism unit 3 which causes a band-shaped coil 100 to convey along the outer circumference of the coil winding jig 2; and a pair of guide members 4 which guide the band-shaped coil 100 conveyed by the coil conveying mechanism unit 3 so as to be wound on the coil winding jig 2.

(Band-Shaped Coil)

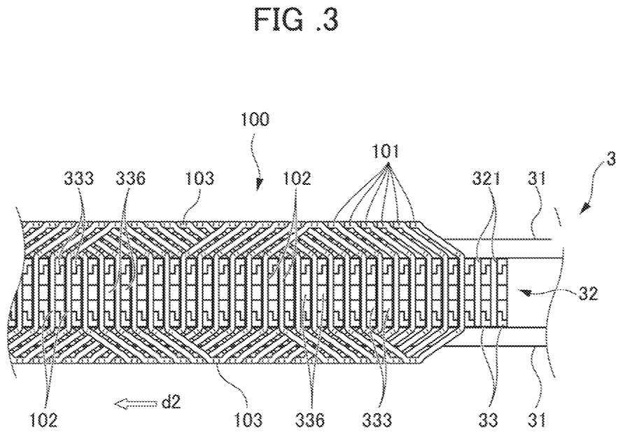

As shown in FIG. 3, the band-shaped coil 100 is molded into an elongated corrugated band-shape by rectangular conductor wires 101 having a substantially rectangular cross-sectional shape. The rectangular conductor wires 101 are formed from a metal having high conductivity such as copper or aluminum, for example.

The band-shaped coil 100 has a plurality of straight portions 102 and a plurality of side ends 103. The straight portions 102 are parts to be inserted in a slot provided in the inner circumference of a stator core which is not illustrated, and are arranged in parallel at a predetermined interval to extend substantially linearly in the same direction, respectively. The side ends 103 are respectively arranged at a position closer to the side end of the band-shaped coil 100 than the straight portion 102, i.e. at both ends in the extending direction of the straight portion 102. The side ends 103 couple adjacent straight portions 102 at one end portion and the other end portion alternately in a mountain shape, and constitute coil end parts, each projecting in an axial direction of the stator core from the stator, upon the band-shaped coil 100 being mounted to the stator of the stator core.

The band-shaped coil 100 of the present embodiment is provided in an elongated band shape by arranging six rectangular conductor wires 101 in a manner in which the plurality of straight portions 102 are provided in parallel to each other at a constant interval, and the plurality of side ends 103 are shifted by the pitch of the straight portions 102 to be stacked. The six rectangular conductor wires 101 are provided by folding the plurality of straight portions 102 and the plurality of side ends 103 respectively in a corrugated shape. The straight portions 102 of the band-shaped coil 100 are stacked in the thickness direction (the vertical direction relative to the paper plane of FIG. 3) of the band-shaped coil 100 by folding back the rectangular conductor wire 101 in the middle. The band-shaped coil 100 of the present embodiment has a length that is wound four times around the coil winding jig 2 to be described later.

(Coil Winding Jig)

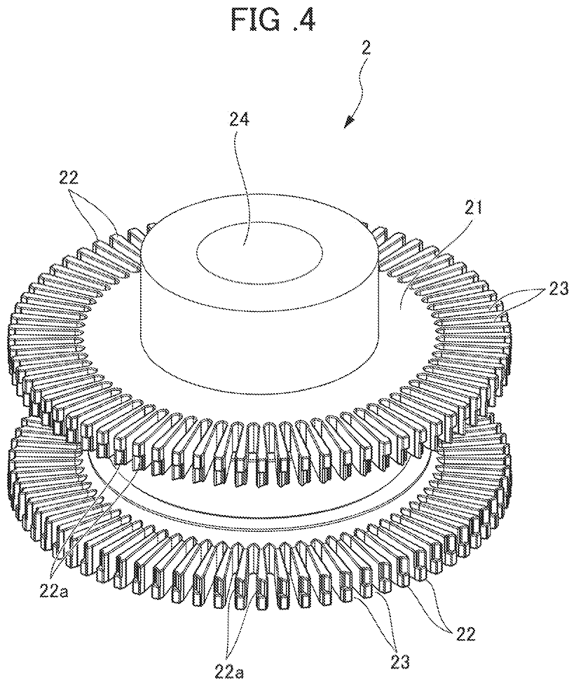

As shown in FIG. 4, the coil winding jig 2 includes: a substantially cylindrical jig main body 21; a plurality of comb teeth 22 protruding radially to the outer circumference of the jig main body 21, a plurality of comb-shaped grooves 23 provided between the adjacent comb teeth 22, 22 in the circumferential direction, and an axial hole 24 opened at the center of the jig main body 21. The comb teeth 22 and comb-shaped groove 23 are respectively provided at both ends in the axial direction of the jig main body 21. The phases of the comb teeth 22 and comb-shaped groove 23 at one end of the jig main body 21 and the comb teeth 22 and comb-shaped groove 23 at the other end are aligned. The coil winding jig 2 of the present embodiment has 72 comb-shaped grooves 23 respectively at both ends in the axial direction of the jig main body 21. The number of these comb-shaped grooves 23 matches the number of slots in the stator core in which the band-shaped coils 100 are mounted.

The interval distance between the comb teeth 22 and comb-shaped groove 23 at one end of the jig main body 21 and the comb teeth 22 and comb-shaped groove 23 at the other end is substantially equal to the length in the extending direction of the straight portion 102 of the band-shaped coil 100. Therefore, the straight portion 102 of the band-shaped coil 100 can be accommodated over the comb-shaped groove 23 at one end and the comb-shaped groove 23 at the other end of the jig main body 21.

The coil winding jig 2 is formed so that the outside diameter of the coil winding jig 2 defined by the position of the leading end of the comb teeth 22 is no more than the inside diameter of the stator core, so that it becomes possible to insert inside of the stator core. The coil winding jig 2 is arranged at a predetermined site of the coil forming apparatus 1, and is provided to be rotatable in the d1 direction shown by the arrow in FIG. 1, centered around the axial hole 24 by driving of a motor which is not illustrated.

(Coil Conveying Mechanism Unit)

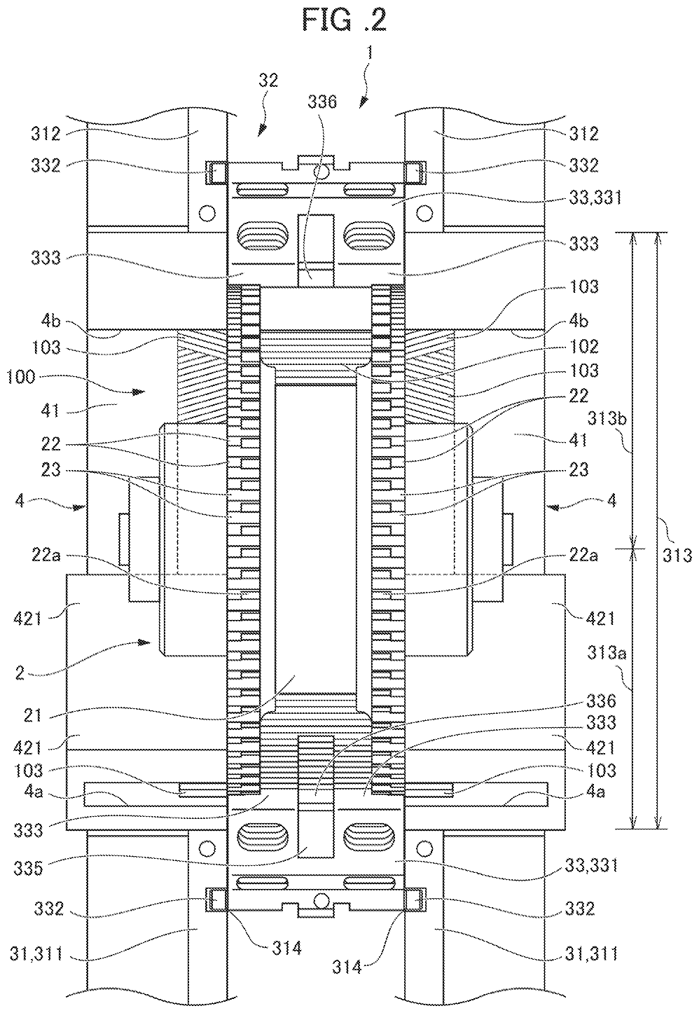

The coil conveying mechanism unit 3 pivotally conveys the band-shaped coil 100 along at least part of the outer circumference of the coil winding jig 2. More specifically, the coil conveying mechanism unit 3 has a pair of conveying rails 31 constituting a conveying path of the band-shaped coil 100, and a conveyor 32 which grips the band-shaped coil 100 and conveys along the conveying rails 31, as shown in FIGS. 1 and 2.

The conveying rails 31 are formed in a band-shaped plate made of metal, and arranged in parallel to each other with substantially equal intervals to the length of the straight portion 102 of the band-shaped coil 100, in the width direction of the coil forming apparatus 1. The interval of the pair of conveying rails 31 is substantially equal to the interval distance in the axial direction of the comb teeth 22 and comb-shaped groove 23 of the coil winding jig 2, as shown in FIG. 2.

The conveying rails 31 includes a pair of upper and lower parallel linear conveying parts 311, 312 forming a linear conveying path, and a pivot conveying unit 313 which connects the ends of the linear conveying parts 311, 312 in an arc shape, thereby forming a lateral U-shaped conveying path. The conveying rails 31 are provided so as to surround the coil winding jig 2 by arranging on the inner side of the U-shaped portion, so that the pivot conveying unit 313 follows the outer circumference of the coil winding jig 2. As shown in FIG. 2, pairs of guide grooves 314 spanning the entire length of the conveying rail 31 are respectively provided to the faces on which the pair of conveying rails 31 are opposing each other. The guide groove 314 forms a travel path of a conveyor 32 described later.

In the present embodiment, the pivot conveying unit 313 of the coil conveying mechanism unit 3 is formed along a range approximately ½ of the outer circumference of the coil winding jig 2. The pivot conveying unit 313 includes a first half portion 313a on the introducing side of the band-shaped coil 100 and a second half portion 313b on the discharging side of the band-shaped coil 100. The first half portion 313a is formed over a range of approximately ½ the first half of the pivot conveying unit 313. The second half portion 313b is provided over a range of approximately ½ the second half of the pivot conveying unit 313. However, the pivot conveying unit 313 may be configured to be able to pivotally convey the band-shaped coil 100 along at least a portion of the outer periphery of the coil winding jig 2.

The conveyor 32 extends long along the conveying rail 31 and can move along the conveying rail 31 between the pair of conveying rails 31. The conveyor 32 has a length corresponding to at least the total length of the band-shaped coil 100, and moves along the conveying rail 31 in a state of holding the straight portions 102 of the band-shaped coil 100 on the upper surface, thereby pivotally conveying the band-shaped coil 100 along the outer periphery of the coil winding jig 2.

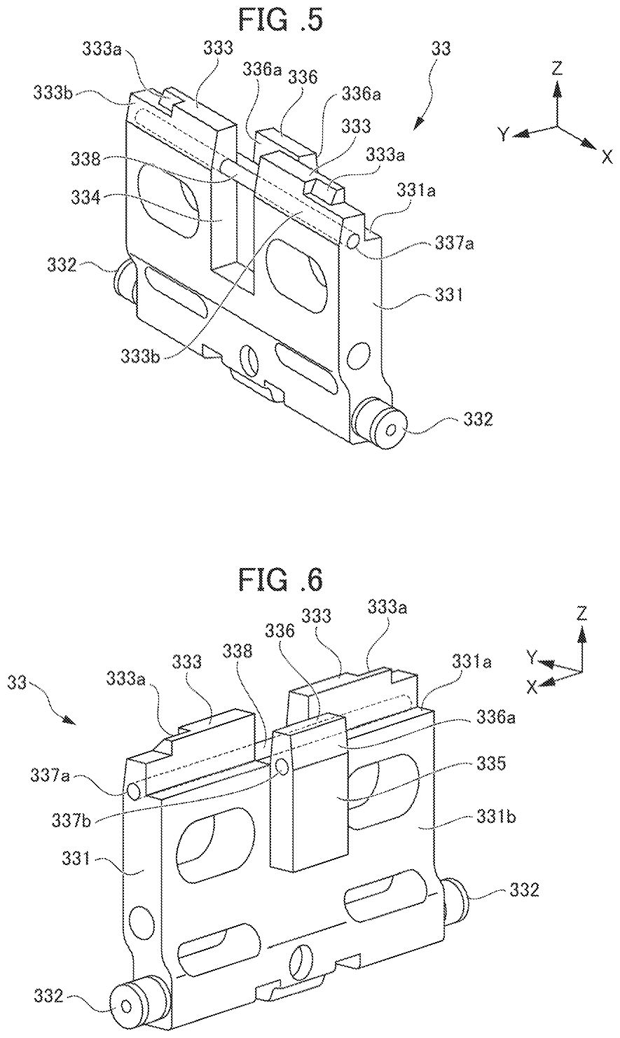

As shown in FIGS. 1 and 3, the conveyor 32 includes a plurality of piece members 33 of the same structure arranged in a multilayer shape to be coupled overlapping along the conveying direction of the band-shaped coil 100. As shown in FIGS. 5, 6 and 7, the piece members 33 each include a piece member body 331 having a substantially rectangular plate-like shape made of metal, and a pair of guide projections 332, each projecting laterally from both ends in the width direction at the lower end of the piece member body 331. The guide projections 332 of the present embodiment each include a rotatable roller; however, they may be simple projections. In addition, regarding the directions of the piece member 33, in FIGS. 5, 6, and 7, the X direction is defined as the width direction, the Y direction is defined as the thickness direction, and the Z direction is defined as the height direction. In the height direction, the upper direction in the drawings is defined as “up”, and the lower direction is defined as “down”.

The piece member body 331 has a thickness substantially equal to the gap between adjacent straight portions 102 and 102 in the length direction of the band-shaped coil 100. The piece member body 331 has an upper end surface 331a, and the upper end surface 331a includes a pair of first gripping claws 333, each projecting in the height direction. The first gripping claw 333 has a thickness of approximately ½ the thickness of the piece member body 331. The thickness of the first gripping claw 333 is substantially equal to the gap between the adjacent straight portions 102 and 102 of the band-shaped coil 100. The first gripping claw 333 is provided at a position in the vicinity of one end in the thickness direction of the piece member body 331 on the upper end surface 331a. The pair of first gripping claws 333 are disposed apart from each other on both end sides in the width direction of the piece member body 331 with a predetermined interval therebetween.

The first gripping claws 333 each have an upper end surface, and the upper end surface includes a meshing groove 333a that meshes with a tip of the comb tooth 22 of the coil winding jig 2. More specifically, as shown in FIG. 4, the tip of the comb tooth 22 of the coil winding jig 2 has an engaging portion 22a. The meshing groove 333a has a position and a shape capable of meshing with the engaging portion 22a of the coil winding jig 2.

The first gripping claws 333 each have a tapered surface 333b on the side opposite to the side on which the upper end surface 331a is provided. The tapered surface 333b allows the first gripping claw 333 to be formed in a slightly tapered shape as it moves away from the piece member body 331.

The pair of first gripping claws 333 has a rectangular recess 334 along the height direction of the piece member body 331 provided therebetween. The recess 334 is provided to span from the upper end surface 331a to the portion approximately ½ the height of the piece member body 331. The depth of the recess 334 along the thickness direction of the piece member body 331 has a depth of approximately ½ the thickness of the piece member body 331, similarly to the first gripping claw 333.

The piece member body 331 includes a rectangular protrusion 335 provided on one side surface 331b. The protrusion 335 is provided to protrude, in the thickness direction of the piece member body 331, in a block shape toward a direction perpendicular to the side surface 331b from the side surface 331b which is opposite to the side where the first gripping claw 333 is provided. The protrusion 335 is provided above a site which is approximately ½ the height of the piece member body 331 in the height direction. The height of the protrusion 335 along the height direction of the piece member body 331 is substantially equal to the height of the recess 334. The thickness of the protrusion 335 along the thickness direction of the piece member body 331 is substantially equal to the depth of the recess 334.

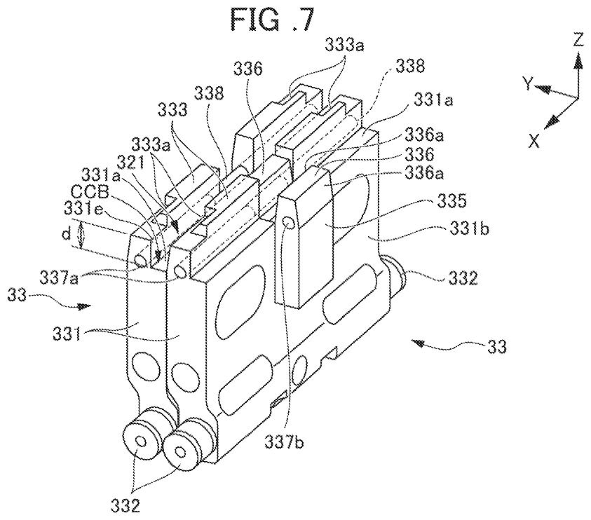

The protrusion 335 includes a second gripping claw 336 provided at an upper end portion thereof. Similarly to the first gripping claws 333, the second gripping claw 336 projects upward from the upper end surface 331a of the piece member body 331. Similarly to the first gripping claws 333, the thickness of the second gripping claw 336 is substantially equal to the gap between the adjacent straight portions 102 and 102 of the band-shaped coil 100. Since the second gripping claw 336 has the same width as the protrusion 335, as shown in FIG. 7, when the two piece members 33 and 33 are stacked with their directions aligned with each other, the second gripping claw 336 of the one piece member 33 is disposed between the pair of first gripping claws 333 and 333 of the other piece member 33.

The second gripping claw 336 has tapered surfaces 336a on both the side on which the upper end surface 331a is provided and the opposite side thereto. These tapered surfaces 336a allow the second gripping claw 336 to be formed in a slightly tapered shape as it moves away from the piece member body 331.

As shown in FIG. 7, the plurality of piece members 33 are aligned such that the first gripping claws 333 and the second gripping claws 336 are oriented in the same direction, and the protrusions 335 of the piece member 33 are stacked so as to be accommodated in the recess 334 of the adjacent piece member 33. As a result, the adjacent piece members 33 and 33 are in close contact with each other and stacked.

The piece member 33 includes a through hole 337a extending in the width direction of the piece member 33 at a portion in the vicinity of the root of the first gripping claw 333 and substantially at the same height as the upper end surface 331a of the piece member body 331. In addition, the protrusion 335 includes a through hole 337b extending in the width direction of the protrusion 335 at a portion in the vicinity of the root of the second gripping claw 336 and substantially at the same height as the upper end surface 331a of the piece member body 331. As shown in FIG. 7, after the two piece members 33 and 33 are stacked, a shaft member 338 is inserted to span the through hole 337a and the through hole 337b which are in communication with each other. Thus, with the shaft member 338 as a rotation axis, the lower end sides of the plurality of pieces members 33 where the guide projections 332 are provided are coupled with each other in a rotatable (swingable) manner in the length direction of the conveyor 32, thereby forming an elongated conveyor 32.

As shown in FIGS. 3, 7, 8, and 9, in the conveyor 32, gripping grooves 321 each gripping the straight portion 102 of the band-shaped coil 100 is provided between the first gripping claws 333 and 333, and between the second gripping claws 336 and 336 of the adjacent piece members 33, 33. The gripping groove 321, as shown in FIG. 7, is formed as a depression of depth d from the introduction opening 331e, which is at the height position of the shoulder at which the first gripping claw 333 rises up from the upper end surface 331a of the piece member main body 331. The bottom part of the gripping groove 321 is an upper end surface 331a of the piece member main body 331.

The depth d of each of the plurality of gripping grooves 321 is set to a dimension according to the overlapping coil conductor number of different straight portions 102 according to the position in the conveying direction of the band-shaped coil 100. The bottom of the depth d of the gripping groove 321 makes a coil abutting bottom surface CCB serving as the abutting surface relative to the coil conductor positioned at the deepest part of the coil conductors gripped by the gripping groove 321. In other words, the coil abutting bottom surface CCB is the bottom of each of the plurality of gripping grooves 321, 321 formed at a site where the plurality of piece members 33, 33 are adjoining of the conveyor 32 configured by the plurality of piece members 33, 33 which are rotatable accompanying pivotal conveying of the band-shaped coil 100 while gripping the plurality of straight portions 102, 102 being coupled to overlap along the conveying direction of the band-shaped coil 100.

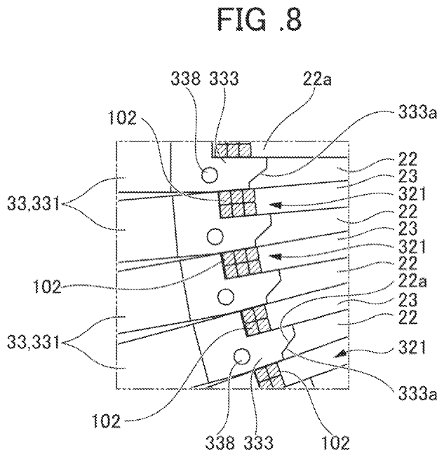

The gripping grooves 321 each have a groove width capable of accommodating the straight portion 102 of the band-shaped coil 100. The groove width of the gripping groove 321 is substantially equal to the groove width along the circumferential direction of the comb-shaped groove 23 of the coil winding jig 2. The arrangement pitch of the gripping grooves 321 along the length direction of the conveyor 32 is substantially equal to the arrangement pitch of the comb-shaped groove 23 along the circumferential direction of the coil winding jig 2. Therefore, when the meshing groove 333a and the engaging portion 22a are engaged with each other, as shown in FIG. 8, the gripping groove 321 of the conveyor 32 and the comb-shaped groove 23 of the coil winding jig 2 are in communication with each other in the radial direction of the coil winding jig 2.

In the conveyor 32, each guide projection 332 of the piece member 33 is slidably accommodated in the guide groove 314 of the conveying rail 31, and protrudes toward the inside of the U-shaped conveying rail 31. Furthermore, as shown in FIG. 8, the meshing groove 333a of the piece member 33 meshes with the engaging portion 22a of the coil winding jig 2 at the location immediately below the coil winding jig 2, such that the conveyor 32 is in synchronization with the rotation of the coil winding jig 2 by the rotation of the coil winding jig 2 in the direction d1 so as to be movable in the direction d2. When the conveyor 32 moves in an arc shape along the pivot conveying unit 313 of the conveying rail 31, the guide projections 332 of the piece members 33 and 33 adjacent to each other rotate by means of the shaft member 338 so as to be isolated with the portions of the first gripping claw 333 and the second gripping claw 336 which are sites for gripping the straight portions 102 as references, such that the conveyor 32 is smoothly movable.

As shown in FIGS. 3, 8, and 9, in the conveyor 32 which is slidably disposed on the conveying rail 31, the first gripping claw 333 and the second gripping claw 336 are inserted into the gap between the straight portions 102 and 102 adjacent to each other in the length direction of the band-shaped coil 100, and the straight portions 102 are accommodated in the respective gripping grooves 321, whereby the band-shaped coil 100 is gripped. Therefore, it is possible for the conveyor 32 to convey the band-shaped coil 100 in a state of holding the straight portions 102 at regular intervals without displacing the straight portions. As shown in FIGS. 2 and 3, the side ends 103 of the band-shaped coil 100 protrude laterally on both sides in the moving direction of the conveyor 32. It should be noted that, in FIG. 1, the band-shaped coil 100 to be gripped by the conveyor 32 is not shown.

(Guide Member)

As shown in FIG. 1, the guide members 4 are made from a metal band-shaped plate material, and provided in a substantially U-shape laterally along the pivot conveying unit 313 of the conveying rail 31. In the guide members 4, the inside of the U-shaped portion is provided so as to face the direction of the coil winding jig 2 in the vicinity of the both ends of the coil winding jig 2 in the axial direction (the vertical direction relative to the paper plane of FIG. 1, and the left-right direction in FIG. 2) so as to sandwich the coil winding jig 2, and is fixed to the conveying rail 31.

The guide member 4 includes an introduction end 4a which introduces the side end 103 of the band-shaped coil 100 conveyed by the conveyor 32, a discharge end 4b which discharges the side end 103 of the band-shaped coil 100, and an inner wall surface 41 which guides the side end 103 from the introduction end 4a to the discharge end 4b. The inner wall surface 41 is formed by a curved surface which smoothly curves continuously from the introduction end 4a to the discharge end 4b so as to follow approximately ½ of the outer periphery of the coil winding jig 2. The guide member 4 smoothly guides the entirety of the band-shaped coil 100 into an arc shape so as to follow the outer circumference of the coil winding jig 2, by causing the side end 103 introduced from the introduction end 4a to contact the inner wall surface 41, while being pivotally conveyed by the pivot conveying unit 313.

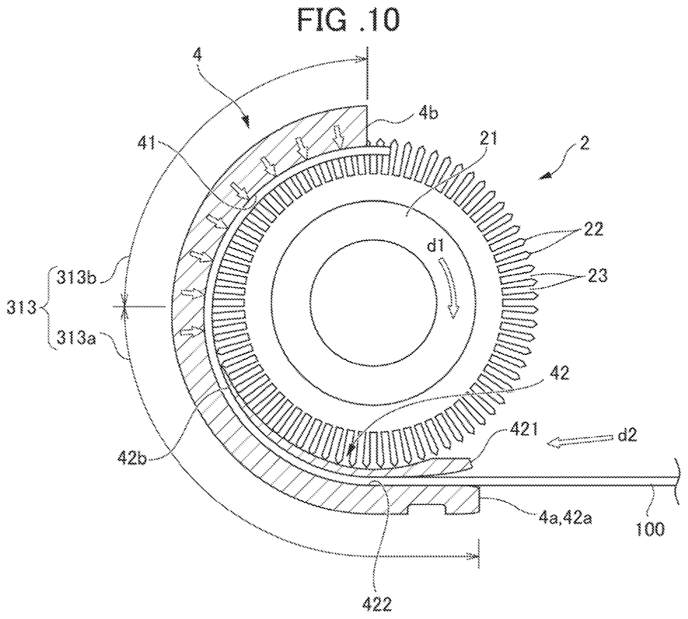

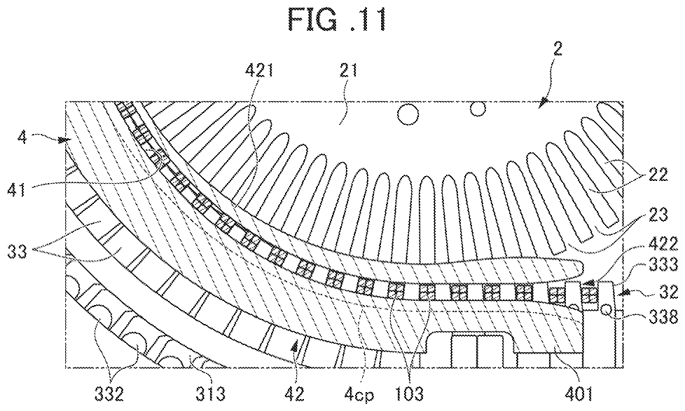

The curvature of the inner wall surface 41 of arc shape of the guide member 4 is formed so as to gradually change greatly as approaching the discharge end 4b from the introduction end 4a. In more detail, as shown in FIG. 10, the inner wall surface 41 of the introduction end 4a is arranged somewhat more to the outer side in the radial direction than the outer circumference of the coil winding jig 2. However, the inner wall surface 41 gradually reduces in diameter smoothly as approaching the discharge end 4b from the introduction end 4a. The inner wall surface 41 at the discharge end 4b is arranged more to the inner side in the radial direction than the outer circumference of the coil winding jig 2. For this reason, the inner wall surface 41 of the guide member 4 guides the band-shaped coil 100 so as to gradually round into an arc of a smaller diameter than the outside diameter of the coil winding jig 2, while contacting the side end 103 of the band-shaped coil 100, as the band-shaped coil 100 approaches the second half portion 313b from the first half portion 313a of the pivot conveying unit 313.

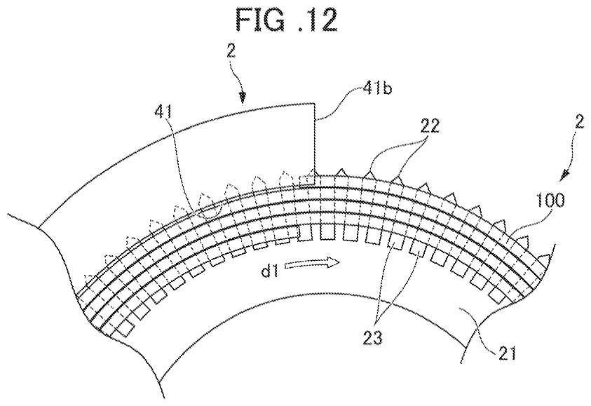

The band-shaped coil 100 is gradually pressed toward the coil winding jig 2, by being guided to the inner wall surface 41 of the guide member 4, as approaching the second half portion 313b from the first half portion 313a of the pivot conveying unit 313. The straight portion 102 gripped by the conveyor 32 thereby forcibly separates from the gripping groove 321 so as to lift up, and gradually moves towards the inside of the comb-shaped groove 23 of the coil winding jig 2. The discharge end 4b of the guide member 4 is arranged more to the inner side in the radial direction than the outer circumference of the coil winding jig 2; therefore, the straight portion 102 is completely inserted into the comb-shaped groove 23 of the coil winding jig 2. Subsequently, the band-shaped coil 100 is wound in the coil winding jig 2 by rotation of the coil winding jig 2. It should be noted that, in FIGS. 10 and 12, the conveyor 32 is omitted from illustration, and the band-shaped coil 100 is shown to be simplified.

It should be noted the guide member 4 is not limited to a structure having the inner wall surface 41 which is continuous over the entirety of the pivot conveying unit 313 as in the present embodiment. The guide member 4, although not illustrated, may be a structure arranging a plurality of guide rollers so as to follow the pivot conveying unit 313, for example. However, in the viewpoint of configuring so as to be able to continuously guide the band-shaped coil 100 to the comb-shaped groove 23 of the coil winding jig 2, and be able to smoothly insert the straight portion 102 into the comb-shaped groove 23, the guide member 4 preferably has the inner wall surface 41 contacting at the wall surface with the side end 103 at the second half portion 313b of the pivot conveying unit 313. In the viewpoint of configuring so as to be able to smoothly guide the band-shaped coil 100 into an arc shape over the entirety of the pivot conveying unit 313, and be able to smoothly insert the straight portion 102 into the comb-shaped groove 23 of the coil winding jig 2, the guide member 4 preferably has the inner wall surface 41 contacting at the wall surface with the side end 103 in the entirety of the pivot conveying unit 313 as in the present embodiment.

As shown in FIGS. 1 and 2, the guide member 4 has, at the side of the introduction end 4a thereof, the pair of reforming portions 42 for causing the band-shaped coil 100 introduced to the pivot conveying unit 313 to forcibly deform and reform so as to curve into an arc shape along the outer circumference of the coil winding jig 2. In the guide member 4, the range in which the reforming portion 42 is provided is within the range of the first half portion 313a of the pivot conveying unit 313. More specifically, the reforming portion 42, for example, can be provided from the introduction end 4a of the guide member 4 over a range of approximately ½ to approximately ¾ of the first half portion 313a of the pivot conveying unit 313.

In other words, the guide members 4 include the reforming portion 42 in the first half portion 313a of the pivotal conveying of the band-shaped coil 100, and the reforming portion 42 deforms and reforms the band-shaped coil 100 in an arc shape in a state sandwiching the side ends 103 of the band-shaped coil 100 in a state in which the plurality of straight portions 102, 102 are gripped in the plurality of gripping grooves 321, 321.

The reforming portion 42 is configured by the inner wall surface 41 of the guide member 4 and guide plates 421. The guide plates 421 are formed so as to smoothly curve in an arc shape along the curvature of the inner wall surface 41 of the guide member 4. The guide plates 421, similarly to the guide member 4, are respectively arranged so as to sandwich the coil winding jig 2 from both end sides in the axial direction, and are fixed to the guide member 4. In the reforming portion 42, a reforming groove 422 pinching the side end 103 is formed between the inner wall surface 41 and guide plate 421. The inner wall surface 41 of the reforming portion 42 contacts and supports the surface on the outer side in the radial direction of the side end 103 of the band-shaped coil 100, and the guide plates 421 contact and support the surface on the inner side in the radial direction of the side end 103 of the band-shaped coil 100.

The reforming portion 42 causes the side end 103 of the band-shaped coil 100 introduced to the introduction end 4a of the guide member 4 to forcibly deform so as to curve into an arc shape, by conveying while being accepted and clamped in the reforming groove 422. The band-shaped coil 100 is reformed into an arc shape, at an early stage of introduction of the pivot conveying unit 313 before winding on the coil winding jig 2, and the force trying to elastically recover to a flat shape while guided to an arc shape by the inner wall surface 41 of the guide member 4 subsequently is suppressed. Therefore, the band-shaped coil 100 is smoothly and precisely molded into the substantially cylindrical wound shape, in combination with being guided into the arc shape by the guide member 4.

(Coil Forming Method)

Next, a method of forming the band-shaped coil 100 into a substantially cylindrical wound state by the coil forming apparatus 1 will be described.

First, the coil winding jig 2 is provided to be rotatable by the driving of a motor (not shown) inside the U-shaped portion of the conveying rail 31 of the coil forming apparatus 1 (coil winding jig arranging step).

After the coil winding jig 2 is provided in the coil forming apparatus 1, the band-shaped coil 100 which is formed in advance in a long corrugated band shape is supplied to the conveyor 32 which is provided in the straight conveying unit 311 on the lower side of the conveying rail 31 by a coil feeding device or an operator (not shown). The band-shaped coil 100 is gripped by the conveyor 32 by inserting the first gripping claws 333 and the second gripping claws 336 of the respective piece members 33 of the conveyor 32 into adjacent gaps of the band-shaped coil 100, and by accommodating the straight portions 102 in the gripping grooves 321, respectively.

In detail, it uses the conveyor 32 with the gripping grooves 321 having the coil abutting bottom surface CCB of depth d according to the number of the coil conductors overlapping of the plurality of straight portions 102, 102 which differ according to the position in the conveying direction of the band-shaped coil 100, and grips the plurality of straight portions 102, 102 by these gripping grooves 321.

Thereafter, the conveyor 32 gripping the base-shaped coil 100 is pressed by a conveyer pressing device (not shown) or an operator, and the straight conveying unit 311 is moved toward the coil winding jig 2 so that the meshing groove 333a of the piece member 33 and the engaging portion 22a of the coil winding jig 2 are engaged with each other. When the coil winding jig 2 is rotationally driven in the direction d1 after the meshing groove 333a and the engaging portion 22a are meshed with each other immediately below the coil winding jig 2, the conveyor 32 moves the conveying rail 31 along the direction d2 in synchronization with the rotation of the coil winding jig 2, and pivotally conveys the band-shaped coil 100 along the outer periphery of the coil winding jig 2 (coil conveying step).

The conveyor 32 applied to conveyance of this band-shaped coil 100 has the gripping grooves 321 having the coil abutting bottom surface CCB of a depth according to the overlapping number of coil conductors in the plurality of straight portions 102 which differ according to the position in the conveying direction of the band-shaped coil 100. The straight portion 102 is held by the gripping groove 321, and the band-shaped coil 100 is conveyed (coil conveying step).

In the coil conveying step, when the conveyor 32 reaches the pivot conveying unit 313, the side end 103 of the band-shaped coil 100 is first introduced into the reforming groove 422 of the reforming portion 42 from the introduction end 4a of the guide member. 4, and is pivotally conveyed while being sandwiched between the inner wall surface 41 and the guide plate 421. Thus, the band-shaped coil 100 is forcibly deformed and reformed so as to be curved in an arc shape along the reforming groove 422 (reforming step).

In other words, in the first half portion 313a of pivotal conveying of the band-shaped coil 100, the side ends 103 of the band-shaped coil 100 are sandwiched in a state gripping the plurality of straight portions 102,102 in the plurality of gripping grooves 321, 321, and the band-shaped coil is deformed and reformed into an arc shape (reforming step).

The band-shaped coil 100 passing through the reforming portion 42 is guided so as to be gradually rounded in an arc shape while being pivotally conveyed along at least a portion of the outer periphery of the coil winding jig 2 along the inner wall surface 41 of the guide member 4, i.e., a range of approximately ½ the outer periphery of the coil winding jig 2, accompanying the rotation of the coil winding jig 2 (guiding step).

Since the curvature of the inner wall surface 41 of the guide member 4 gradually increases from the first half portion 313a to the second half portion 313b of the pivot conveying unit 313, the side end 103 of the band-shaped coil 100 is pressed by the inner wall surface 41 so as to gradually decrease the diameter inwardly in the radial direction. Thus, the band-shaped coil 100 is rounded to have a smaller diameter than the outer diameter of the coil winding jig 2. The side end 103 which is pressed against the inner wall surface 41 gradually separates the straight portions 102 from the gripping grooves 321 toward the comb-shaped groove 23 of the coil winding jig 2 as the band-shaped coil 100 approaches the discharge end 4bb of the guide member 4. As shown in FIG. 10, the straight portions 102 completely detached from the gripping grooves 321 are inserted into the respective comb-shaped grooves 23 of the coil winding jig 2 in communication with the gripping grooves 321, while being pressed against the inner wall surface 41 of the guide member 4 (inserting step). Subsequently, the band-shaped coil 100 is discharged from the discharge end 4bb of the guide member 4, while being wound in the coil winding jig 2, accompanying rotation of the coil winding jig 2.

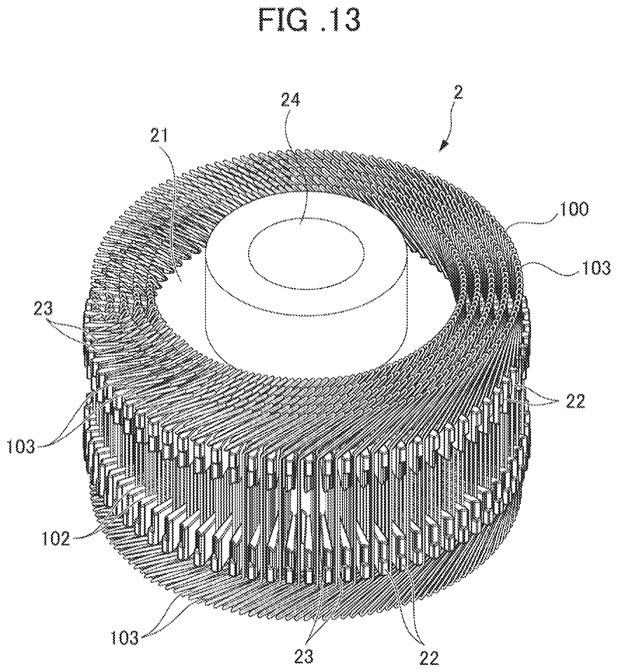

If the entirety of the conveyor 32 finishes moving along the conveying rails 31, the band-shaped coil 100 is wound four times around the coil winding jig 2 to be multiply wound, as shown in FIG. 12, by the coil conductors of the straight portions 102 being introduced into the comb-shaped grooves 23 in a layered manner. The band-shaped coil 100 is thereby easily molded into a substantially cylindrical wound state, as shown in FIG. 13. Since the straight portions 102 of the band-shaped coil 100 in the wound state is accommodated within the comb-shaped grooves 23, there is no concern of displacing. Therefore, the band-shaped coil 100 can stably hold the substantially cylindrical wound state. It should be noted that the band-shaped coil is not limited to being multiply wound on the coil winding jig 2.

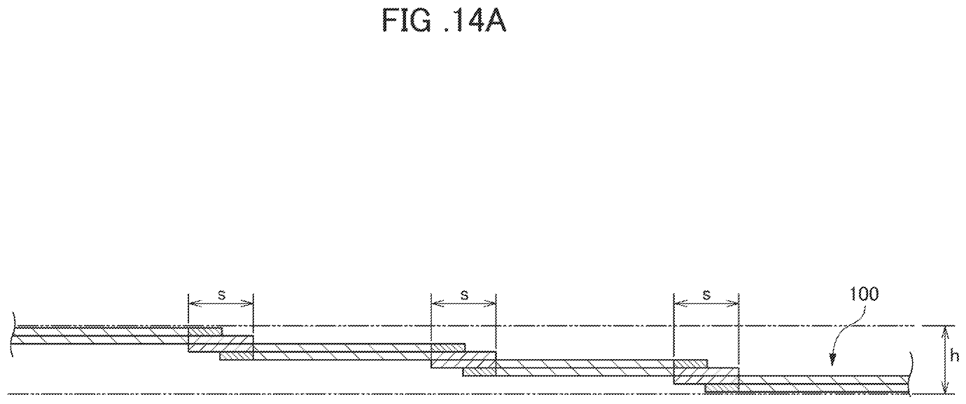

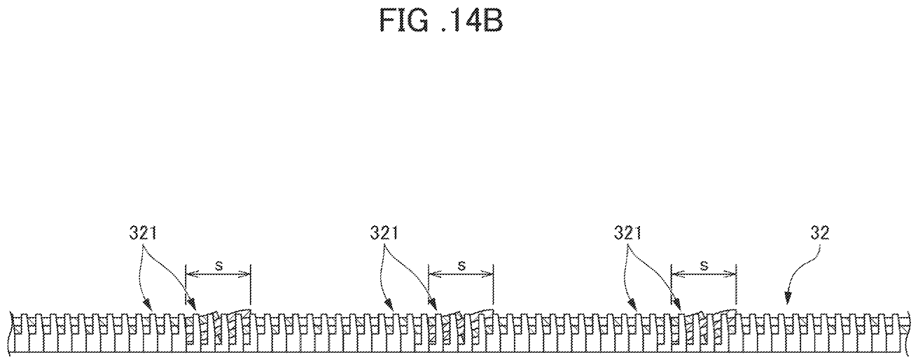

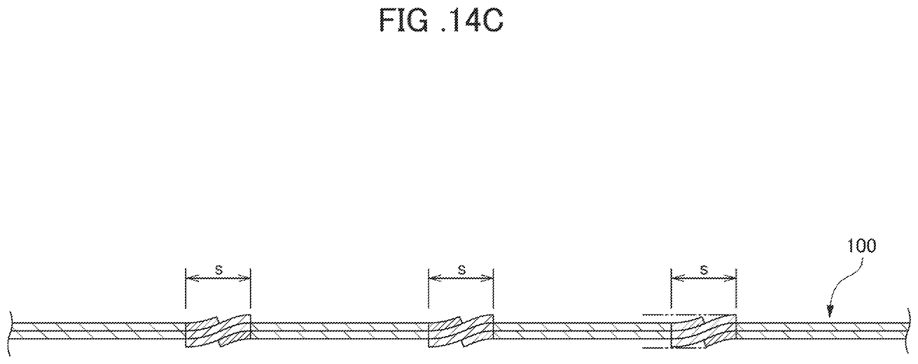

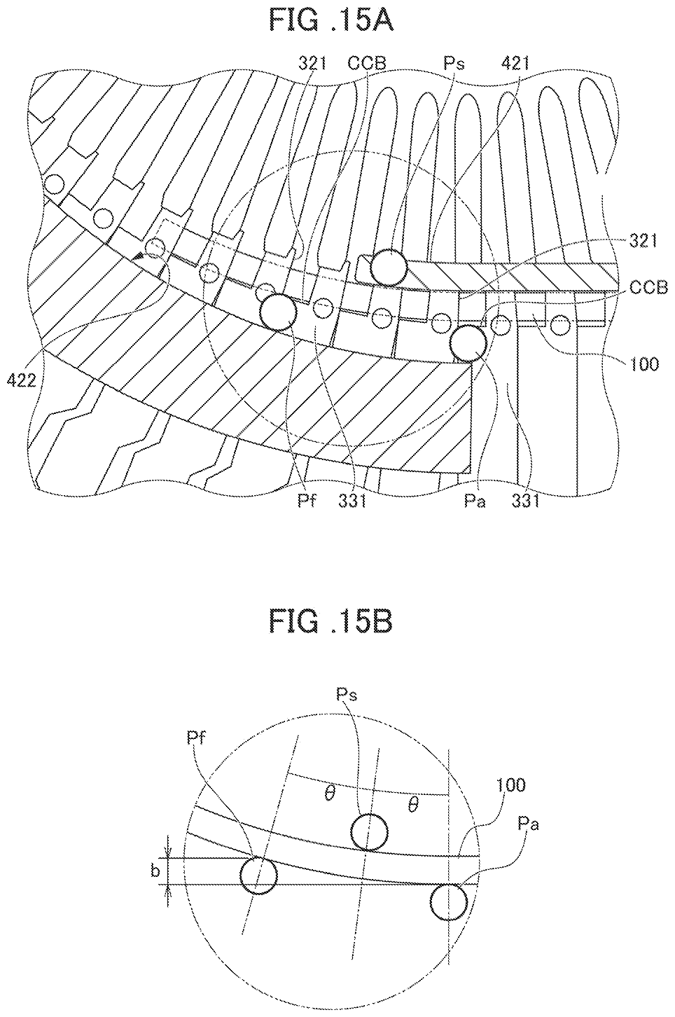

Next, the characteristics of the embodiment of the present invention will be further explained by referencing FIGS. 14A, 14B and 14C, along with FIGS. 15A and 15B. FIG. 14A is a conceptual diagram showing in a side view the band-shaped coil 100 from the first turn to fourth turn to be expanded in the direction of the conveying path of linear shape of the coil forming apparatus 1 in every orbit, in the case of multiplex winding the band-shaped coil 100 by winding around the coil winding jig 2 so as to make 4 turns, as mentioned above. In FIG. 14A, the coil conductor of each orbit of the first turn, second turn, third turn and fourth turn from left to right is shown. It should be noted that the way of counting of each orbit herein calls the coil conductor on the outermost circumference side of the 4-turn multiplex winding as first turn coil conductor, calls the coil conductor of a turn immediately after this coil conductor as a second turn coil conductor, and calls the following sequence as third and fourth turn coil conductors.

Therefore, the fourth turn coil conductor is the inner most coil conductor in multiplex winding. The coil conductor of each orbit is two layers; however, in the specific region S corresponding to the switching site of each orbit, a step arises in the lamination direction of coil conductors due to reversing and folding back the coil conductors. For this reason, an elevation difference of height h arises from the lower end position of the band-shaped coil 100 in FIG. 14A, which is a surface on the inner circumferential side of the fourth turn coil conductor, until the upper end position of the band-shaped coil 100 in FIG. 14A, which is a surface on the outer circumferential side of the first turn coil conductor.

Herein, the reforming operations on the band-shaped coil 100 positioned in the reforming portion 42 will be considered in mechanical terms. In FIG. 15A, the force acting on the band-shaped coil 100 is conceptually shown in the case of deforming and reforming the band-shaped coil 100 gripped by the gripping grooves 321 formed in the piece member main bodies 331 of the coil conveying mechanism unit 3, by the guide plate 421 of the reforming portion 42. FIG. 15B shows abstractly the force in FIG. 15A to be enlarged. The coil conductors of the band-shaped coil 100 positioned in the reforming portion 42 is gripped by the gripping grooves 321, and supported by the coil abutting bottom surface CCB. The coil abutting bottom surface CCB acts as force point Pf and working point Pa on the coil conductors of the band-shaped coil 100, and the site of the guide plate 421 making sliding contact with the intermediate position of the force point Pf and working point Pa acts as a fulcrum Ps. By the force acting on this force point Pf and working point Pa, as well as the working point Pa, the band-shaped coil 100 is curved by the curvature amount b between the force point Pf and working point Pa to be reformed into an arc shape.

However, when evenly setting the depth d of the gripping grooves 321 explained referencing FIG. 7 in accordance with the elevation difference h in FIG. 14A, a portion at which the guide plate 421 functioning as the fulcrum Ps does not come into contact with the coil conductor of the band-shaped coil 100 appears in the coil abutting bottom surface CCB functioning as the force point Pf and working point Pa. At such a portion, it is not possible to make the required bending habit in the band-shaped coil 100.

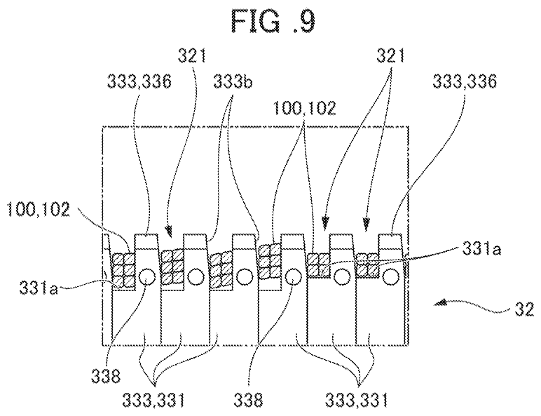

Therefore, in the embodiment of the present invention, as shown in FIG. 14B, the depth d of the gripping grooves 321 is established as a depth which can just accommodate the step appearing in the lamination direction of the coil conductors by reversing and folding back the coil conductors only for the specific region S, and regions other than the specific region S are made evenly in accordance with the lamination number (two layers in present example) of the coil conductors. The gripping grooves 321 in the specific region S and in the vicinity thereof and the coil conductors gripped therein assume forms such as those of FIGS. 8 and 9. In other words, the depth d of any gripping groove 321 is a depth according to the overlapping number of the coil conductors of the straight portion 102, and a void such that contact with the aforementioned fulcrum Ps is inhibited does not arise. It should be noted that the upper end surface 331a of the piece member main body 331 in FIG. 9 is the aforementioned coil abutting bottom surface CCB.

By setting the depth d of the gripping groove 321 as in FIG. 14B, the band-shaped coil 100 becomes substantially flat over the entire range in the conveying direction as shown in FIG. 14C, and there is no longer an elevation difference h relative to lamination of the coil conductors in the conveying direction of the band-shaped coil 100 such as that in FIG. 14A. The guide plate 421 thereby comes to be able to effectively function as the fulcrum Ps, relative to the coil abutting bottom surface CCB functioning as the force point Pf and working point Pa explained by referencing FIG. 15A and FIG. 15B, over the entire region in the conveying direction of the band-shaped coil 100. Therefore, it is possible to perform predetermined reforming on the band-shaped coil 100.

According to the above explained coil forming apparatus 1, the following effects are exerted. In other words, a coil forming apparatus 1 of the present invention forms a band-shaped coil 100 in a wound state, the band-shaped coil 100 including a plurality of straight portions 102 and side ends 103 provided on both ends of the plurality of straight portions 102, the coil forming apparatus 1 including: a coil winding jig 2 having a plurality of comb-shaped grooves 23, and configured to be capable of winding the band-shaped coil 100 by inserting the plurality of straight portions 102 of the band-shaped coil 100 into a respective on the plurality of comb-shaped grooves 23; a coiling conveying mechanism unit 3 configured to be capable of pivotal conveying the band-shaped coil 100; and guide members 4 that are provided in a vicinity of both ends of the coil winding jig 2 in an axial direction, and guide the band-shaped coil 100 in an arc shape while being in contact with the side end 103 of the band-shaped coil 100, and insert the plurality of straight portions 102 in a respective one of the plurality of comb-shaped grooves 23 in a second half portion of pivotal conveying of the band-shaped coil 100, in which the coil conveying mechanism unit 3 includes a conveying rail 31 that provides a conveying path pivotally conveying the band-shaped coil 100 along the coil winding jig 2, and a conveyor 32 that moves along the conveying rail 31 in a state gripping each of the plurality of straight portions 102 of the band-shaped coil 100, the conveyor 32 has a plurality of gripping grooves 321 which grip a respective one of the plurality of straight portions 102 of the band-shaped coil 100, and the plurality of gripping grooves 321 have a coil abutting bottom surface CCB of a depth according to an overlapping number of the plurality of straight portions 102 which differs according to position in a conveying direction of the band-shaped coil 100. For this reason, upon deforming and reforming on the band-shaped coil 100 into an arc shape, force acts appropriately on the coil abutting bottom surface CCB functioning as the force point Pf and working point Pa giving force for this reforming, and from the corresponding site of the guide member 4 as the fulcrum Ps relative to this, and thus can make predetermined bending habit in the band-shaped coil.

In the coil forming apparatus 1, the coil abutting bottom surface CCB is the bottom of each of the plurality of gripping grooves 321 formed at a site at which the plurality of piece members 33 adjoin of the conveyor 32 configured by the plurality of piece members 33 which are rotatable accompanying pivotal conveying of the band-shaped coil 100 while gripping the plurality of straight portions 102 being coupled to overlap along the conveying direction of the band-shaped coil 100. For this reason, the conveyor 32 can smoothly pivotally convey the coil conductors of the band-shaped coil 100 into an arc shape while gripping with the gripping grooves 321.

In the coil forming apparatus 1, the guide members 4 include the reforming portion 42 in the first half portion of the pivotal conveying of the band-shaped coil 100, and the reforming portion 42 deforms and reforms the band-shaped coil 100 in an arc shape in a state sandwiching the side ends 103 of the band-shaped coil 100 in a state in which the plurality of straight portions 102 are gripped in the plurality of gripping grooves 321. For this reason, the force for making the bending habit in the band-shaped coil 100 appropriately acts on the coil abutting bottom surface CCB functioning as the force point Pf and working point Pa, and from the corresponding site of the guide member 4 as the fulcrum Ps relative to this, and thus can make the predetermined bending habit in the band-shaped coil.

The coil forming method of the present embodiment has the following advantageous effects. In other words, the coil forming method of the present embodiment is for forming the band-shaped coil 100 in a wound state, the band-shaped coil 100 including a plurality of straight portions 102 and side ends 103 provided on both ends of the plurality of straight portions 102, the method including: a coil conveying step of pivotally conveying the band-shaped coil 100 in a state gripping each of the plurality of straight portions 102, along a coil winding jig 2, the coil winding jig 2 including a plurality of comb-shaped grooves 23 on an outer periphery thereof, each of which can hold a respective one of the plurality of straight portions 102 therein, and being configured to wind the band-shaped coil 100, and a guiding step of providing guide members 4 in a vicinity of both ends of the coil winding jig 2 in an axial direction, guiding the band-shaped coil 100 so as to be in an arc shape while the side ends 103 of the band-shaped coil 100 being pivotally conveyed are in contact with the guide members 4, and inserting the plurality of straight portions 102 into a respective one of the plurality of comb-shaped grooves 23 of the coil winding jig, in which the coil conveying step uses a conveyor 32 having gripping grooves 321 having a coil abutting bottom surface CCB of a depth according to an overlapping number of the plurality of straight portions 102 which differs according to position in a conveying direction of the band-shaped coil 100 to grip the plurality of straight portions 102 by the gripping grooves 321. For this reason, upon deforming and reforming on the band-shaped coil 100 into an arc shape, force acts appropriately on the coil abutting bottom surface CCB functioning as the force point Pf and working point Pa giving force for this reforming, and from the corresponding site of the guide member 4 as the fulcrum Ps relative to this, and thus can make predetermined bending habit in the band-shaped coil.

In the coil forming method of the present embodiment, the coil conveying step uses the conveyor 32 in which the plurality of piece members 33 which are rotatable accompanying pivotal conveying of the band-shaped coil 100 while gripping the plurality of straight portions 102 are coupled to overlap along the conveying direction of the band-shaped coil 100, and grips the plurality of straight portions 102 with the gripping grooves 321 in which the coil abutting bottom surface CCB is configured as the bottom of each of the plurality of gripping grooves 321 formed at the site where the plurality of piece members 33 adjoin. For this reason, the band-shaped coil 100 can be gripped by the gripping grooves 321 and smoothly pivotally conveyed into an arc shape the coil conductors by the conveyor 32.

In the coil forming method of the present embodiment, the coil conveying step includes a reforming step of sandwiching the side ends 103 of the band-shaped coil 100 in a state gripping the plurality of straight portions 102 in the plurality of gripping grooves 321 in a first half portion of pivotal conveying of the band-shaped coil 100, and deforming and reforming of the band-shaped coil 100 into an arc shape. For this reason, the force for making a bending habit in the band-shaped coil appropriately acts, and it is possible to make a predetermined bending habit in the band-shaped coil.

Although embodiments of the present invention have been explained above, the present invention is not to be limited thereto. The configurations of detailed parts may be modified where appropriate within the scope of the gist of the present invention. For example, in the aforementioned embodiment, in order to establish the depth d of the gripping groove 321 as different depths than other regions for the region corresponding to region S in FIG. 14B, although the piece members 33 having different dimensions of the corresponding parts, an alternate configuration can be adopted. In other words, the piece members 33 may be prepared as having entirely the same shape and same dimension, and may be configured so as to laminate a dummy member in the gripping grooves 321 for adjusting the depth d.

### EXPLANATION OF REFERENCE NUMERALS

1 coil forming apparatus
2 coil winding jig
23 comb-shaped groove
3 coil conveying mechanism unit
31 conveying rail
313 pivot conveying unit
313a first half portion
313b second half portion
314 guide groove
32 conveyor
321 groove entrance
33 piece member
333 first gripping claw
336 second gripping claw
4 guide member
41 inner wall surface
42 reforming portion
100 band-shaped coil
102 straight portion
103 side end
CCB coil abutting bottom surface
d depth
Pa working point
Pf force point
Ps fulcrum

What is claimed is:

1. A coil forming apparatus that forms a band-shaped coil in a wound state, the band-shaped coil including a plurality of straight portions and side ends provided on both ends of the plurality of straight portions, the coil forming apparatus comprising:
a coil winding jig having a plurality of comb-shaped grooves, and configured to be capable of winding the band-shaped coil by inserting the plurality of straight portions of the band-shaped coil into a respective on the plurality of comb-shaped grooves;
a coiling conveying mechanism unit configured to be capable of pivotal conveying the band-shaped coil; and
guide members that are provided in a vicinity of both ends of the coil winding jig in an axial direction, and guide the band-shaped coil in an arc shape while being in contact with the side end of the band-shaped coil, and insert the plurality of straight portions in a respective one of the plurality of comb-shaped grooves in a second half portion of pivotal conveying of the band-shaped coil,
wherein the coil conveying mechanism unit includes a conveying rail that provides a conveying path pivotally conveying the band-shaped coil along the coil winding jig, and a conveyor that moves along the conveying rail in a state gripping each of the plurality of straight portions of the band-shaped coil,
wherein the conveyor has a plurality of gripping grooves which grip a respective one of the plurality of straight portions of the band-shaped coil, and
wherein the plurality of gripping grooves have a coil abutting bottom surface of a depth according to an overlapping number of the plurality of straight portions which differs according to position in a conveying direction of the band-shaped coil.

2. The coil forming apparatus according to claim 1, wherein the coil abutting bottom surface is a bottom part of each of the plurality of gripping grooves provided at a site at which the plurality of piece members adjoin of the conveyor configured by a plurality of the piece members which are rotatable accompanying pivotal conveying of the band-shaped coil while gripping the plurality of straight portions being coupled to overlap along the conveying direction of the band-shaped coil.

3. The coil forming apparatus according to claim 1, wherein the guide members include a reforming portion in a first half portion of the band-shaped coil upon pivotal conveying, and the reforming portion deforms and reforms the band-shaped coil in an arc shape in a state sandwiching the side ends of the band-shaped coil in a state gripping the plurality of straight portions in the plurality of gripping grooves.

4. A coil forming method for forming a band-shaped coil in a wound state, the band-shaped coil including a plurality of straight portions and side ends provided on both ends of the plurality of straight portions, the method comprising:
a coil conveying step of pivotally conveying the band-shaped coil in a state gripping each of the plurality of straight portions, along a coil winding jig, the coil winding jig including a plurality of comb-shaped grooves on an outer periphery thereof, each of which can hold a respective one of the plurality of straight portions therein, and being configured to wind the band-shaped coil, and
a guiding step of providing guide members in a vicinity of both ends of the coil winding jig in an axial direction, guiding the band-shaped coil so as to be in an arc shape while the side ends of the band-shaped coil being pivotally conveyed are in contact with the guide members, and inserting the plurality of straight portions into a respective one of the plurality of comb-shaped grooves of the coil winding jig,
wherein the coil conveying step uses a conveyor having gripping grooves having a coil abutting bottom surface of a depth according to an overlapping number of the plurality of straight portions which differs according to position in a conveying direction of the band-shaped coil to grip the plurality of straight portions by the gripping grooves.

5. The coil forming method according to claim 4, wherein the coil conveying step uses the conveyor in which a plurality of piece members which are rotatable accompanying pivotal conveying of the band-shaped coil while gripping the plurality of straight portions are coupled to overlap along the conveying direction of the band-shaped coil, and grips the plurality of straight portions by the gripping groove in which the coil abutting bottom surface is provided as a bottom of each of the plurality of gripping grooves provided at a site where the plurality of piece members adjoin.

6. The coil forming method according to claim 4, wherein the coil conveying step further includes a reforming step of deforming and reforming the band-shaped coil in an arc shape, by sandwiching the side ends of the band-shaped coil in a state gripping the plurality of straight portions in the plurality of gripping grooves, in a first half portion of the band-shaped coil upon pivotal conveying.
